(19) United States
(12) Patent Application Publication
(10) Pub. No.: US 2026/0154376 A1
(43) Pub. Date: Jun. 4, 2026

(54) SYNTHETIC SANDBOX VALIDATION INTEROPERABILITY LAYER FOR CLINICAL ARTIFICIAL INTELLIGENCE

(71) Applicant: George William Bickerstaff, III, Greenwich, CT (US)

(72) Inventor: George William Bickerstaff, III, Greenwich, CT (US)

(21) Appl. No.: 19/455,884

(22) Filed: Jan. 22, 2026

(51) Int. Cl. G06F 18/21; G06F 21/53

(52) U.S. Cl. CPC G06F 18/217; G06F 21/53

(57) ABSTRACT

A synthetic sandbox validation interoperability layer enables regulator-verifiable testing of artificial intelligence systems using synthetic data. Artificial intelligence models are executed in a hardware-isolated environment, evaluated against validation baselines, and issued cryptographically signed exit reports upon success. Deployment is permitted only after successful validation, providing a safe and scalable conformity assessment mechanism.

### TECHNICAL FIELD

The present invention relates to validation, conformity assessment, and lifecycle governance systems for artificial intelligence operating in regulated environments.

More particularly, the invention relates to hardware-isolated synthetic sandbox environments that enable deterministic testing, stress validation, and regulatory verification of artificial intelligence systems prior to deployment.

The invention provides a standardized interoperability layer that produces cryptographically verifiable validation artifacts suitable for regulatory submission, audit, and post-market oversight.

### BACKGROUND

Artificial intelligence systems intended for clinical and diagnostic use must demonstrate safety, robustness, and performance across a wide range of operating conditions.

Traditional validation approaches rely on retrospective datasets, prospective clinical trials, or limited pilot deployments, each of which presents cost, time, and ethical constraints.

Increasing regulatory guidance permits the use of synthetic data and simulated environments to supplement or replace portions of human-subject testing.

Existing sandbox solutions lack deterministic enforcement, cryptographic verification, and execution boundary controls required for high-stakes regulatory use.

Software-only validation platforms may be altered, bypassed, or fail to capture rare edge conditions encountered in real-world deployment.

There exists a need for a validation environment that produces regulator-verifiable evidence while preventing premature or unsafe deployment.

The present invention addresses these deficiencies by providing a hardware-enforced synthetic sandbox validation interoperability layer.

### SUMMARY OF THE INVENTION

The disclosed invention provides a controlled synthetic sandbox for validating artificial intelligence systems using simulated clinical data.

Artificial intelligence models are executed within a hardware-isolated environment and subjected to predefined stress scenarios, edge cases, and distributional shifts.

Performance outcomes are measured against validation baseline profiles and regulator-approved thresholds.

Successful validation results in generation of a cryptographically signed exit report authorizing progression toward deployment.

Validation failure results in deterministic blocking of execution beyond an execution boundary.

All validation activities and outcomes are recorded in immutable audit logs suitable for regulatory review and lifecycle governance.

### DEFINITIONS

Execution Boundary means a control point at which artificial intelligence outputs would affect downstream systems, workflows, or decisions.

Exit Report means a cryptographically signed artifact summarizing sandbox validation conditions, performance outcomes, and compliance status.

Interoperability Layer means a standardized interface enabling exchange of validation artifacts with external regulatory, audit, or deployment systems.

Synthetic Dataset means artificially generated data designed to simulate statistical, temporal, and structural characteristics of real-world data.

Synthetic Sandbox means a controlled execution environment for artificial intelligence validation that is isolated from production systems.

Stress Scenario means a predefined simulation condition designed to test artificial intelligence behavior under adverse or extreme inputs.

Trusted Execution Environment means a hardware-protected isolated execution space that prevents unauthorized access or modification.

Validation Baseline Profile means an approved reference defining acceptable performance, safety, and robustness thresholds.

Violation Signal means a deterministic signal indicating validation failure or non-compliance.

Validation Artifact means any cryptographically verifiable record generated during sandbox execution, including metrics, logs, or reports.

### BRIEF DESCRIPTION OF THE DRAWINGS

FIG. 1 illustrates sandbox architecture.

FIG. 2 illustrates synthetic data generation.

FIG. 3 illustrates simulation execution.

FIG. 4 illustrates validation enforcement.

FIG. 5 illustrates reporting and auditing.

### DETAILED DESCRIPTION OF THE DRAWINGS

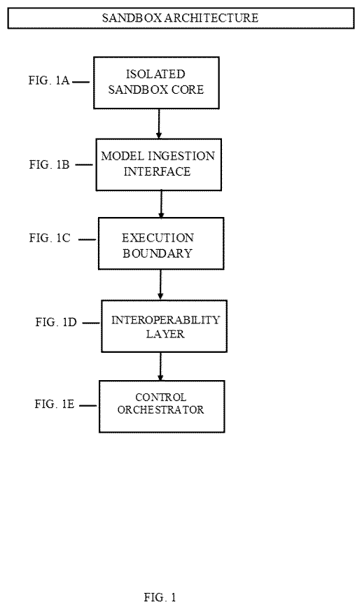

### FIG. 1—Sandbox Architecture

FIG. 1A—ISOLATED SANDBOX CORE illustrates a hardware-isolated synthetic sandbox core operating within a trusted execution environment. The core executes artificial intelligence models without exposure to production systems. Unauthorized interference is prevented by hardware enforcement.

FIG. 1B—MODEL INGESTION INTERFACE illustrates controlled ingestion of an artificial intelligence model into the sandbox. Model execution is restricted to the sandbox environment. Initialization outside the sandbox is blocked.

FIG. 1C—EXECUTION BOUNDARY illustrates an execution boundary separating sandbox execution from deployment environments. Outputs cannot cross the boundary without successful validation. Enforcement is deterministic.

FIG. 1D—INTEROPERABILITY LAYER illustrates a standardized interface enabling communication with external validation and regulatory systems. Interfaces authenticate and serialize validation artifacts. Integrity is preserved.

FIG. 1e—CONTROL ORCHESTRATOR illustrates orchestration of sandbox workflows and execution order. Scenario sequencing is enforced. Unauthorized actions are blocked.

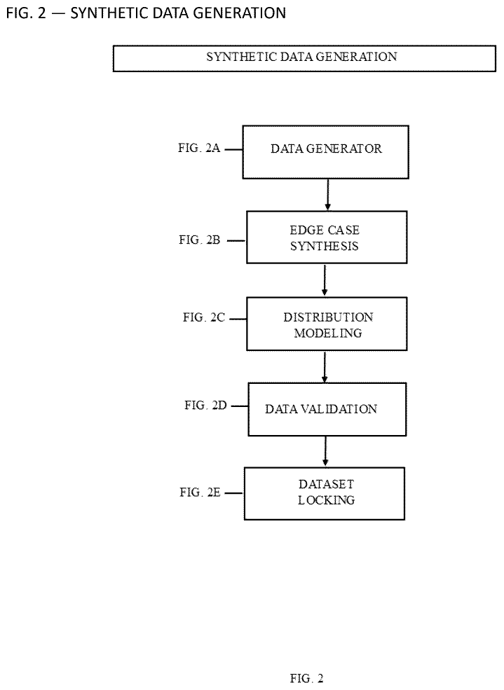

### FIG. 2—Synthetic Data Generation

FIG. 2a—DATA GENERATOR illustrates generation of synthetic datasets modeling real-world statistical properties. Data generation avoids use of live patient data. Privacy risk is eliminated.

FIG. 2b—EDGE CASE SYNTHESIS illustrates creation of rare, extreme, or adversarial scenarios. Edge cases reflect regulator-defined risk profiles. Stress coverage is expanded.

FIG. 2C—DISTRIBUTION MODELING illustrates modeling of data distributions and distributional shifts. Controlled variability is introduced. Realism is enforced.

FIG. 2D—DATA VALIDATION illustrates validation of synthetic datasets prior to simulation execution. Invalid datasets are rejected. Integrity is ensured.

FIG. 2E—DATASET LOCKING illustrates locking of approved datasets for simulation use. Locked datasets cannot be altered. Reproducibility is preserved.

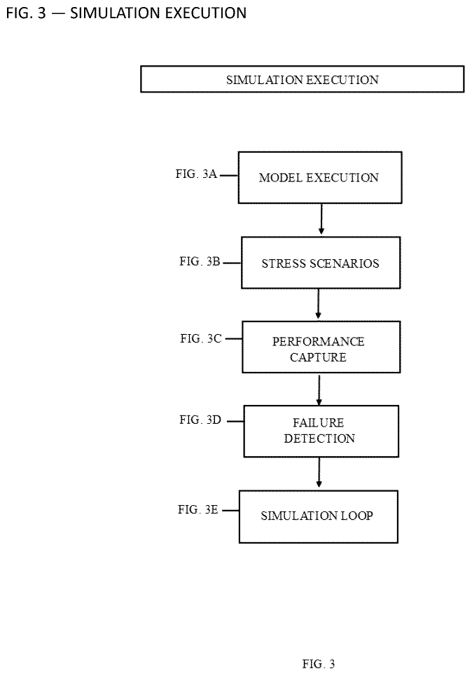

### FIG. 3—Simulation Execution

FIG. 3A—MODEL EXECUTION illustrates execution of the artificial intelligence model within the sandbox. Execution is isolated from production systems. Outputs are captured for analysis.

FIG. 3b—stress scenarios illustrates application of predefined stress scenarios to the model. Scenarios include noise, drift, and adversarial inputs. Robustness is evaluated.

FIG. 3c—PERFORMANCE CAPTURE illustrates continuous capture of performance metrics during simulation. Metrics include accuracy, confidence, and error patterns. Measurement is comprehensive.

FIG. 3d—FAILURE DETECTION illustrates detection of performance failures relative to validation baselines. Failures generate violation signals. Execution may halt.

FIG. 3E—SIMULATION LOOP illustrates iterative simulation cycles across varied conditions. Coverage expands across runs. Validation depth increases.

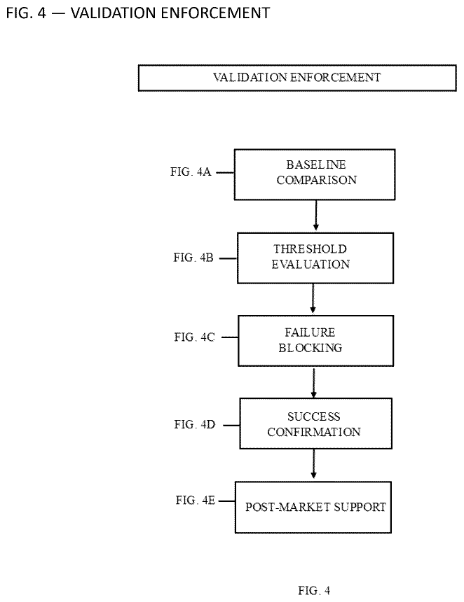

### FIG. 4—Validation Enforcement

FIG. 4A—BASELINE COMPARISON illustrates comparison of performance metrics to validation baseline profiles. Deviations are detected deterministically. Compliance is assessed.

FIG. 4B—THRESHOLD EVALUATION illustrates evaluation against predefined performance thresholds. Thresholds are regulator-approved. Enforcement is automatic.

FIG. 4C—FAILURE BLOCKING illustrates blocking of deployment upon validation failure. Outputs do not cross the execution boundary. Safety is preserved.

FIG. 4D—SUCCESS CONFIRMATION illustrates confirmation of successful validation outcomes. Confirmation permits report generation. Deployment remains gated.

FIG. 4E—POST-MARKET SUPPORT illustrates extension of the sandbox for post-market surveillance. Ongoing validation is supported. Lifecycle governance is enabled.

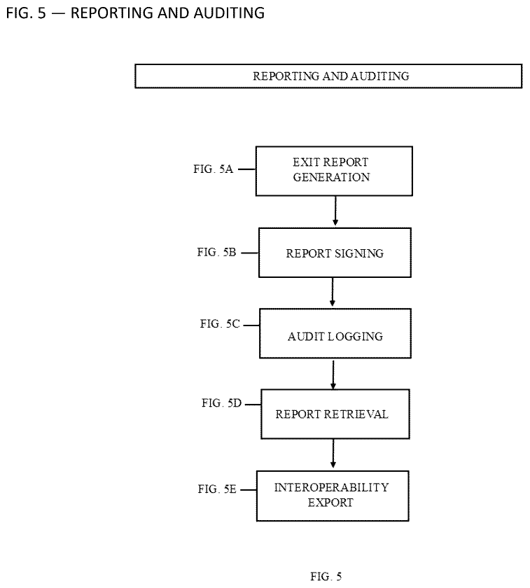

### FIG. 5—Reporting and Auditing

FIG. 5A—EXIT REPORT GENERATION illustrates generation of a cryptographically signed exit report. The report summarizes validation conditions and outcomes. Authenticity is verifiable.

FIG. 5B—REPORT SIGNING illustrates cryptographic signing of the exit report. Signing ensures non-repudiation. Regulator trust is supported.

FIG. 5c—AUDIT LOGGING illustrates recording of validation activities in immutable audit logs. Logs are append-only. Tampering is prevented.

FIG. 5d—REPORT RETRIEVAL illustrates retrieval of validation artifacts for regulatory review. Retrieval is read-only. Transparency is preserved.

FIG. 5E—INTEROPERABILITY EXPORT illustrates export of validation artifacts through the interoperability layer. Standard formats are supported. Integration is simplified.

### EXAMPLES

In one example, a clinical AI model is evaluated using synthetic patient populations including rare adverse scenarios. The model fails under stress and deployment is blocked. An exit report documents the failure.

In another example, a model passes all synthetic stress tests and baseline thresholds. A signed exit report is generated and submitted for regulatory review. Deployment proceeds only after approval.

1. A system for validating artificial intelligence using synthetic data, comprising:
a hardware-isolated synthetic sandbox configured to execute an artificial intelligence model;
a validation engine configured to compare performance outcomes to validation baseline profiles; and
control logic configured to prevent deployment beyond an execution boundary unless validation is successful.

2. A computer-implemented method comprising:
executing an artificial intelligence model within a synthetic sandbox using synthetic datasets;
evaluating performance outcomes against predefined validation thresholds; and
blocking deployment when validation criteria are not satisfied.

3. A validation controller operating within a trusted execution environment, configured to generate a cryptographically signed exit report upon successful sandbox validation.

4. The system of claim 1, wherein synthetic datasets include edge-case scenarios.

5. The method of claim 2, wherein validation failure generates a violation signal.

6. The validation controller of claim 3, wherein exit reports are recorded in immutable audit logs.

7. The system of claim 1, wherein validation occurs prior to any clinical deployment.

8. The method of claim 2, wherein validation supports post-market surveillance obligations.

9. The validation controller of claim 3, wherein exit reports are retrievable through an interoperability layer.

10. The system of claim 1, wherein modification of the artificial intelligence model invalidates prior validation results.
